(19) United States
(12) Patent Application Publication
(10) Pub. No.: US 2004/0255643 A1
(43) Pub. Date: Dec. 23, 2004

(54) High-performance separation microcolumn assembly and method of making same

(76) Inventors: Kensall D. Wise, Ann Arbor, MI (US); Richard Sacks, Ann Arbor, MI (US); Joseph A. Potkay, Bay Village, OH (US); Masoud Agah, Ann Arbor, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 10/861,036

(22) Filed: Jun. 4, 2004

Related U.S. Application Data
(63) Continuation-in-part of application No. 10/437,101, filed on May 13, 2003.

(51) Int. Cl. G01N 30/02

(52) U.S. Cl. 73/23.39

(57) ABSTRACT

A high-performance separation microcolumn assembly and method for making such an assembly are provided. The assembly includes high-performance Si-glass μGC separation columns having integrated heaters and temperatures sensors for temperature programming and integrated pressure sensors for flow control. These columns, integrated on a die, are fabricated using a silicon-on-glass dissolved-wafer-process. The TCR of the temperature sensors and the sensitivity of the pressure sensors satisfy the requirements needed to achieve reproducible separations in a μGC system. Using these columns, highly-resolved multiple-component separations were obtained with analysis times a factor of two faster than isothermal responses.

### CROSS-REFERENCE TO RELATED APPLICATION

This application is a continuation-in-part of and claims the benefit of pending U.S. patent application entitled “Separation Microcolumn Assembly for a Microgas Chromatograph and the Like,” filed May 13, 2003 and having Ser. No. 10/437,101.

### STATEMENT REGARDING FEDERALLY SPONSORED RESEARCH OR DEVELOPMENT

This invention was made with Government support under Award No. EEC-9986866, awarded by NSF-ERC. The Government has certain rights in the invention.

### BACKGROUND OF THE INVENTION

1. Field of the Invention

This invention relates to separation microcolumn assemblies for microgas chromatographs and the like, and methods for making such assemblies.

2. Background Art

The following documents are referenced herein:

[1] J. A. Potkay et al., “A High-Performance Microfabricated Gas Chromatography Column,” IEEE MEMS CONF., pp. 395-398, 2003.

[2] M. Agah et al., “Thermal Behavior of High-Performance Temperature-Programmed Microfabricated Gas Chromatography Columns,” IEEE INT. CONF. ON SOLID-STATE SENSORS, ACTUATORS AND MICROSYSTEMS, Boston, pp. 1339-1342, June, 2003.

[3] E. S. Kolsear et al., “Review and Summary of a Silicon Micromachined Gas Chromatography System,” IEEE TRANS. COMPONENTS, PACKAGING, AND MANUFACTURING TECHNOLOGY, 66, pp. 481-486, 1998.

[4] H. Noh et al., “Parylene Gas Chromatographic Column for Rapid Thermal Cycling,” IEEE J. OF MICROELECTROMECH. SYST., 11, pp. 718-725, 2002.

[5] R. W. Tjerkstra et al., “Etching Technology for Chromatography Microchannels,” ELECTROCHIMICA ACTA., 42, pp. 3399-3406, 1997.

[6] E. B. Overton et al., “Trends and Advances in Portable Analytical Instrumentation,” FIELD ANALYTICAL CHEMISTRY AND TECHNOLOGY, 1, pp. 87-92, 1996.

[7] H. M. McNair et al., “Fast Gas-Chromatography: The Effect of Fast Temperature Programming,” J. OF MICROCOLUMN SEPARATION, 12, pp. 351-355, 2000.

[8] F. R. Gonzalez et al., “Theoretical and Practical Aspects of Flow Control in Programmed-Temperature Gas Chromatography,” J. OF CHROMATOGRAPHY A, 757, pp. 97-107, 1997.

[9] R. Ong et al., “Influence of Chromatographic Conditions on Separation in Comprehensive Gas Chromatography,” J. OF CHROMATOGRAPHY A, 962, pp. 135-152, 2002.

[10] L. M. Blumberg et al., “Elution Parameters in Constsant-Pressure, Single-Ramp Temperature-Programmed Gas Chromatography,” J. OF CHROMATOGRAPHY A, 918, pp. 113-120, 2001.

[11] L. M. Blumberg et al., “Quantitative Comparison of Performance of Isothermal and Temperature-Programmed Gas Chromatography,” J. OF CHROMATOGRAPHY A, 933, pp. 13-26, 2001.

[12] A. DeHennis et al., “A Double-Sided Single-Chip Wireless Pressure Sensor,” IEEE MEMS CONF., pp. 252-255, 2002.

[13] J. A. Plaza et al., “Effect of Silicon Oxide, Silicon Nitride and Polysilicon Layers on the Electrostatic Pressure During Anodic Bonding,” SENSORS AND ACTUATORS A, 67, pp. 181-184, 1998.

The following U.S. patent documents are related to the invention: U.S. Pat. Nos. 6,527,835; 6,096,656; 6,527,890; 6,386,014; 6,270,641; 6,134,944; 6,068,780; 5,792,943; 5,583,281; 5,544,276; 4,881,410; 5,377,524; 5,989,445; 5,992,769; and 6,109,113.

The following U.S. patent documents were cited by the Examiner in the above-noted patent application: U.S. Pat. Nos. 4,966,037; 5,792,943; 5,796,152; 6,068,684; 6,091,050; 6,184,504; 6,288,371; 6,527,890; and 6,612,153.

Gas chromatography (GC) systems are instruments that separate the different components of a gaseous mixture in space and time [1,2]. In a GC system, a gas sample is vaporized and injected into a separation column that has been coated with a stationary phase. Different gaseous molecules spend different amounts of time in the stationary phase coating while traversing the column so that they emerge from it separated in time. The gases then pass over a detector, generating an electrical output signal proportional to the concentration of the compound. The delay through the column identifies the species present [1-3].

Conventional GCs tend to be large, fragile, and relatively expensive table-top instruments with high power consumption, but they are known to deliver accurate and selective analysis. Microsystems based on chromatography are a promising approach to gas analysis and are rapidly moving toward small portable microinstruments. Such systems will make gas chromatography a pervasive method of gas analysis, with application in homeland security, monitoring food freshness, industrial process control, and improving environment quality [2]. They promise to actually increase performance while drastically decreasing size and cost.

The basic—and heart—of a μGC system is its separation column. There have been many efforts to miniaturize such columns (along with the rest of the instrument) [1-6]; however, column development faces difficult challenges in minimizing power and in implementing the complex temperature and pressure control needed to enhance performance. Temperature programming can be used to separate samples over a broad boiling range and reduces the analysis time [2,7]. Pressure control is also required to achieve reproducible separations since variations in the flow rate affect the retention times [8].

Theoretical Discussion

A common way to express the performance of GC columns is to determine the number of theoretical plates (N) as well as the height-equivalent-to-a-theoretical-plate (HETP). A theoretical plate is a discrete section in which a solute molecule equilibrates between the stationary and mobile phases. For square channels, HETP is given by [1]:

$$HETP = 2 \frac{{D}_{g}}{U} + \frac{1 + 9 k + \frac{51}{2} {k}^{2}}{105 {( 1 + k )}^{2}} \frac{u {w}^{2}}{{D}_{g}} + \frac{8 {h}^{2} ku}{3 {{D}_{l} ( 1 + k )}^{2}} \qquad ( 1 )$$

where D_{g} and Dₗ are the diffusion coefficients in the gas and liquid phases, respectively, k is the retention factor, h is the thickness of the liquid phase, and w is the channel width. To determine the total resolving power of a column, the total number of plates, N, is calculated as:

$$N = \frac{L}{HETP} \qquad ( 2 )$$

where L is the column length.

Analysis time is also a key factor in determining the quality of chemical analyzers, especially when it comes to near real-time applications. In a GC system, a gas mixture is separated as its components distribute between mobile and stationary phases over time. All components spend the same time in the mobile phase, equal to the unretained peak time, given by:

$${t}_{m} = \frac{L}{\overline{u}} \qquad ( 3 )$$

where \overline{u} is the average carrier gas velocity. Retention time (tᵣ) is the time spent by a compound in both phases. The adjusted retention time considers only the time spent in the stationary phase:

tᵣ=tᵣ−tₘ (4)

and finally, the retention factor or capacity factor of a solute is defined as:

$$k = \frac{{t}_{r}^{′}}{{t}_{m}} \qquad ( 5 )$$

The capacity factor is specific for a given compound and is constant under constant conditions [9].

Column temperature has a significant influence on component retention and separation. At a given temperature, the elution order of compounds will not depend on other GC conditions. However, in a temperature programming scenario, analytes may change their relative positions as the temperature changes while they pass through the column [9]. Temperature programming will cause a continuous, monotonic change in the retention factor for each analyte [9-11]:

$$ln k = A + \frac{B}{T} \qquad ( 6 )$$

where A and B are empirical constants and T is the temperature. Increasing the temperature reduces the retention factor and hence decreases the analysis time.

It is shown explicitly in [11] that an isothermal GC in comparison to a temperature-programmed GC provides the highest separation capacity but at the expense of noticeably longer analysis time. Using longer columns in a temperature-programmed GC compensates for its disadvantage in separation capacity while still retaining considerably shorter analysis time. Raising the column temperature reduces the carrier gas viscosity and hence for a constant inlet pressure, the flow rate decreases. Therefore, flow control is required to maintain a constant flow rate during analysis in order to prevent variations of retention times and degradation of the separation efficiency [8].

### SUMMARY OF THE INVENTION

An object of the present invention is to provide a high-performance separation microcolumn assembly and a method for making such an assembly wherein at least one heater and at least one sensor are integrated with the separation column to enhance performance of the assembly.

In carrying out the above object and other objects of the present invention, a high-performance separation microcolumn assembly includes a substrate having a plurality of closed-spaced, gas flow microchannels etched therein. A cover is connected to the substrate to sealingly close the microchannels. The substrate and the cover form a separation column. At least one heater and at least one sensor are integrated with the separation column to enhance performance of the separation column.

The substrate may be a wafer-based substrate.

The cover may be a glass wafer bonded to the substrate.

The at least one sensor may include at least one temperature sensor, and the at least one heater and the at least one temperature sensor may allow the temperature of the separation column to be controlled.

The at least one sensor may include a thermally-based microflow sensor.

The at least one sensor may also include at least one pressure sensor to allow gas flow within the microchannels to be controlled.

The at least one pressure sensor may be disposed between the substrate and the cover in fluid communication with a port of the separation column.

Further in carrying out the above object and other objects of the present invention, in a microgas chromatograph system, a high-performance separation microcolumn assembly to separate a gas sample flowing therethrough into separate compounds is provided. The assembly includes a substrate having a plurality of closely-spaced, gas flow microchannels etched therein. A cover is connected to the substrate to sealingly close the microchannels. The substrate and the cover form a separation column. At least one heater and at least one sensor are integrated with the separation column to enhance separation of the gas sample flowing through the microchannels into separate compounds.

The substrate may be a wafer-based substrate.

The cover may be a glass wafer bonded to the substrate.

The at least one sensor may include at least one temperature sensor, and the at least one heater and the at least one temperature sensor may allow temperature of the separation column to be controlled.

The at least one sensor may include a thermally-based microflow sensor.

The at least one sensor may also include at least one pressure sensor to allow gas flow within the microchannels to be controlled.

The at least one pressure sensor may be disposed between the substrate and the cover in fluid communication with a port of the separation column.

Yet still further in carrying out the above object and other objects of the present invention, a method of making a high-performance microcolumn assembly is provided. The method includes providing a substrate and a cover, and etching a plurality of closely-spaced, gas flow microchannels in the substrate. The cover is connected to the substrate to sealingly close the microchannels and form a separation column. The method further includes forming at least one heater and at least one sensor integrated with the separation column.

The substrate may be a wafer-based substrate and the cover may be a glass wafer. The step of connecting may include the step of bonding the glass wafer to the wafer-based substrate.

The at least one sensor may include at least one pressure sensor, and the at least one pressure sensor may be disposed between the substrate and the cover in fluid communication with a port of the separation column after the step of connecting.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIGS. 1a-1e are side sectional schematic views illustrating one embodiment of a method of the present invention wherein the method utilizes a silicon-on-glass dissolved wafer process;

FIG. 2a is an enlarged top perspective schematic view, partially broken away, showing the separation column entry and pressure sensors;

FIG. 2b is an enlarged bottom schematic view, partially broken away, showing pressure sensor electrodes, the column entry and an etched silicon rim having reduced thermal mass;

FIG. 2c is an enlarged side schematic view, partially broken away and in cross-section, showing a non-thinned, etched-back column;

FIG. 2d is an enlarged bottom schematic view, partially broken away, showing the back or bottom of the column;

FIG. 3a illustrates chromatograms for a 3 meter column with air used as a carrier gas wherein 20 compounds are separated at room temperature; and

FIG. 3b illustrates chromatograms for the 3 meter column with air wherein the same mixture is separated with the column run at 30° C. for 1 minute followed by a temperature ramp of 5° C./min for 5 minutes.

### DETAILED DESCRIPTION OF THE PREFERRED EMBODIMENTS

In general, a high-performance μGC separation column assembly having integrated heaters and temperature sensors for temperature programming as well as integrated pressure sensors for flow control is described herein. The assembly may be part of a μGC intended for an environmental monitoring system. However, it is to be understood that other sensors could be integrated with the assembly such as a thermally-based microflow sensor.

Fabrication of the assembly is preferably based on the silicon-on-glass dissolved-wafer process.

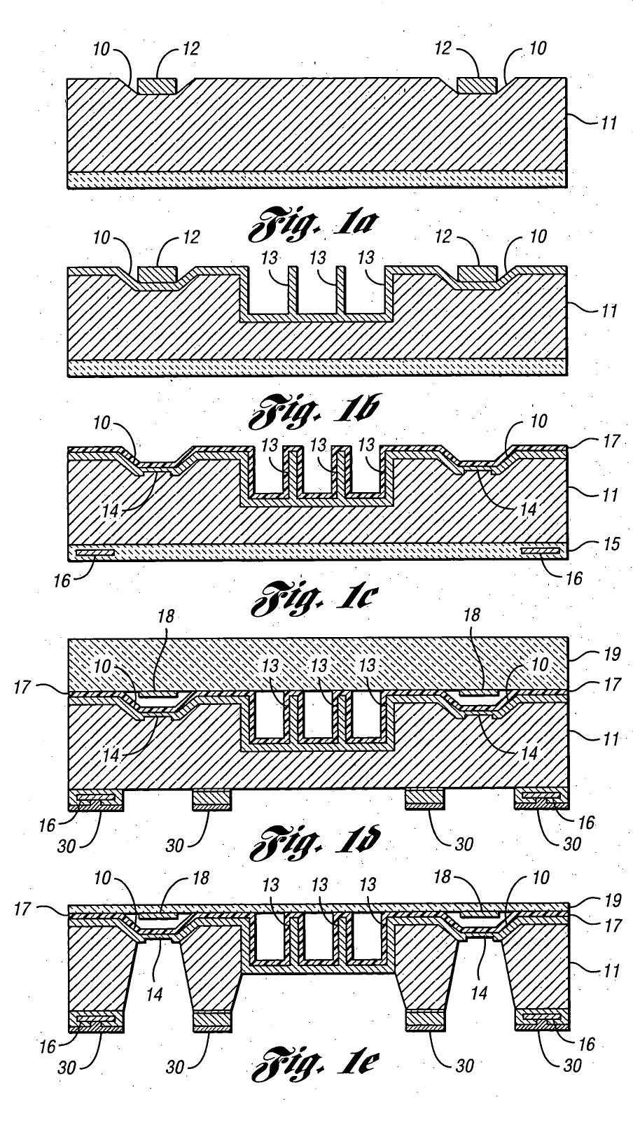

As shown in FIG. 1a, recessed areas 10 are created in a silicon substrate 11 to form cavities and a flow tunnel for pressure sensors and a lead tunnel for glass electrodes. Then, a 1.2 μm thick thermal oxide 12 is grown to protect the cavities during a deep boron diffusion.

As shown in FIG. 1b, using patterned PR9260 as a mask, DRIE is used to etch the silicon substrate 11 to form rectangular microchannels 13 in a 3.333 cm square area and reduce the thermal mass of a silicon rim of the substrate 11. After stripping the resist, highly boron-doped etch-stops are diffused into the channel area, followed by a 4 μm shallow boron diffusion to form the sensor membranes 14, as shown in FIG. 1e. A 2000 Å oxide 15 is grown on the back as an electrical isolation layer and subsequently 250/500 Å of Ti/Pt is evaporated and patterned using lift-off to form the heaters and temperature sensors 16. A 3.000 Å thick LTO deposition 17 on both sides of the wafer is used to stress-compensate the tensile p++ diaphragm 14 [12] and anneal the temperature sensors 16. The LTO thickness on the front should not exceed the aforementioned value, otherwise it will degrade anodic bonding performance [13]. A 1 μm thick LTO layer is deposited on the back side to serve as a mask in EDP. Bottom electrodes and metal interconnects for the pressure sensors 18 are patterned onto the glass wafer 19 with an evaporated Ti/Pt/Au stack.

Then, the wafers 11 and 19 are anodically bonded to, seal the channels 13 at 400° C., 1000V, and 200N of pressure, as shown in FIG. 1d. Next, the back oxide is patterned to open EDP etch windows and contact areas for the heaters 16, temperature sensors 16, and the bulk. Cr/Au is then sputtered and patterned on the back of the silicon substrate 11 to form metal interconnects 30 and cover the silicon rim for heat distribution. The glass wafer 19 is thinned in HF for 45 minutes to reduce the thermal mass. Alternatively, another thinning technique such as CMP (i.e., Chemical Mechanical Polishing) could be used or a thinner glass wafer (i.e., about 1000 μm thick) could be used to eliminate the thinning step. A support wafer is temporarily attached to the back side to protect it during this long etch. In addition, the solution is stirred to obtain a smooth surface. This step thins the glass, to less than 80 μm.

Following glass thinning, EDP is employed to etch back the column and release the pressure sensors (FIG. 1e). With the columns fabricated, fused silica capillaries are attached to the side ports for fluidic interconnects, and the columns are coated with polydimethylsiloxane, a non-polar stationary phase.

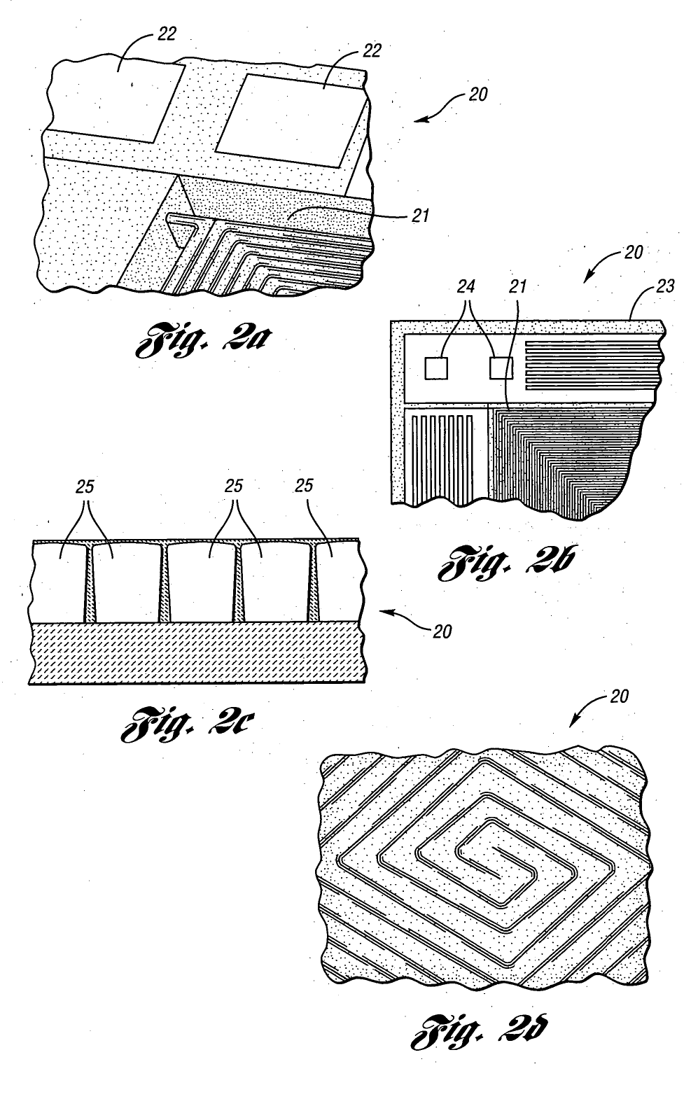

FIGS. 2a-2d show the fabricated etched-back separation column, generally indicated at 20. Each column port 21 has its own pressure sensor 22. Consequently, measurements of pressure differences are independent of ambient fluctuations and the column temperature. FIG. 2a, which shows the pressure sensors 22, displays a device without a gold ring, causing significant undercut. As seen in FIG. 2b, the silicon rim 23 has been selectively etched to reduce the thermal mass. Pressure sensor electrodes 24 are connected to the pressures sensors 22 FIG. 2c is a sectional view of a non-thinned, etched-back column showing channels 25 and FIG. 2d is a schematic view of the column back. Different temperature sensors were also defined on the die to explore the thermal behavior of the column at various points. Moreover, one heater was integrated on each side of the die to suppress temperature gradients around the heaters and reduce temperature non-uniformity of the column during transients [2].

Thermal Behavior

Details of the steady-state power requirements of Si-glass simple columns are discussed in [2]. The thermal behavior of the etched-back columns is similar to those of simple columns listed in Table 1 except for their transient response.

TABLE 1
Required Sustained Power for T_{column} = 100° C.

| | | |
|---|---|---|
| Directly on PCB @ | Free Space | 4.4 W |
| atmospheric pressure | 7.5 mm-high package | 3.4 W |
| Standoffs, gold protection, | Atmospheric pressure | 650 mW |
| and metal package | Vacuum | 100 mW |

Analogous to its electrical counterpart, the thermal time constant can be estimated as:

tₜₕ=Rₜₕ×Cₜₕ (7)

where Rₜₕ×Cₜₕ are the effective thermal resistance and capacitance of the system.

Thermal resistance and power consumption (Pₛₛ) are related as:

$${P}_{ss} = \frac{Δ T}{{R}_{th}} \qquad ( 8 )$$

where ΔT denotes the temperature rise of the column. To lower the power consumption, the thermal resistance should be increased by isolating the column from its surrounding environment, using standoffs and vacuum packaging to reduce both convective and conductive losses and covering the column surface with a lower emissivity material such as gold to shrink radiative losses [2].

The thermal capacitance is given by:

$${C}_{th} = {\sum }_{}^{} {C}_{th , i} = {\sum }_{i}^{} {m}_{i} {\tilde{C}}_{i} \qquad ( 9 )$$

where m and \tilde{C} are the mass and specific heat of each component of the column, respectively. For the same input power, the etched-back columns show a similar steady-state temperature but a much high heating rate due to their lower thermal mass. To obtain a temperature ramp of 40° C./min with a final temperature of 100° C. under the vacuum conditions listed in Table 1, the power source should deliver 1.2 W and 600 mW for simple and etched-back columns, respectively, during transients. Although the cool-down of the etched-back columns is also faster due to the lower mass, for the 3 m-long silicon-glass columns, this thermal time constant is still very significant. For columns having a thermal capacitance of 0.7 J/° C., the thermal time constant in vacuum at 100 mW of steady-state power consumption is still about 9 minutes.

Separation Performance

The temperature sensors integrated with these columns have TCRs of 2000 ppm/° C., sufficient to allow column temperature to be controlled to <0.5° C. The pressure sensors should be operated in the vicinity of the flow rate where the HETP is minimized. It has been found experimentally that the maximum separation efficiency is obtained with a flow velocity of ˜10 cm/s, corresponding to a pressure drop of 5-10 kPa across the 3 m column. Around this point, the pressure sensors have a sensitivity of 52 fF/kPa, allowing adequate flow control to ensure reproducible separations. The burst pressure of the columns is above 50 psi.

With the sensors calibrated, different experiments were conducted to explore the separation capabilities of the columns. The chromatograms used air as the carrier gas and a commercial flame-ionization detector. Experimentally, the number of plates can be calculated as [1]:

$$N = 5.545 {( \frac{{t}_{R}}{{w}_{1 / 2}} )}^{2} \qquad ( 10 )$$

where w_{1/2} is the width of the peak at half height. The numbers of plates were calculated using an isothermal separation and were found to be approximately 8000. This is significantly higher than the previously reported value of 4900 [1] due to improvements in the coating techniques for the μGC columns.

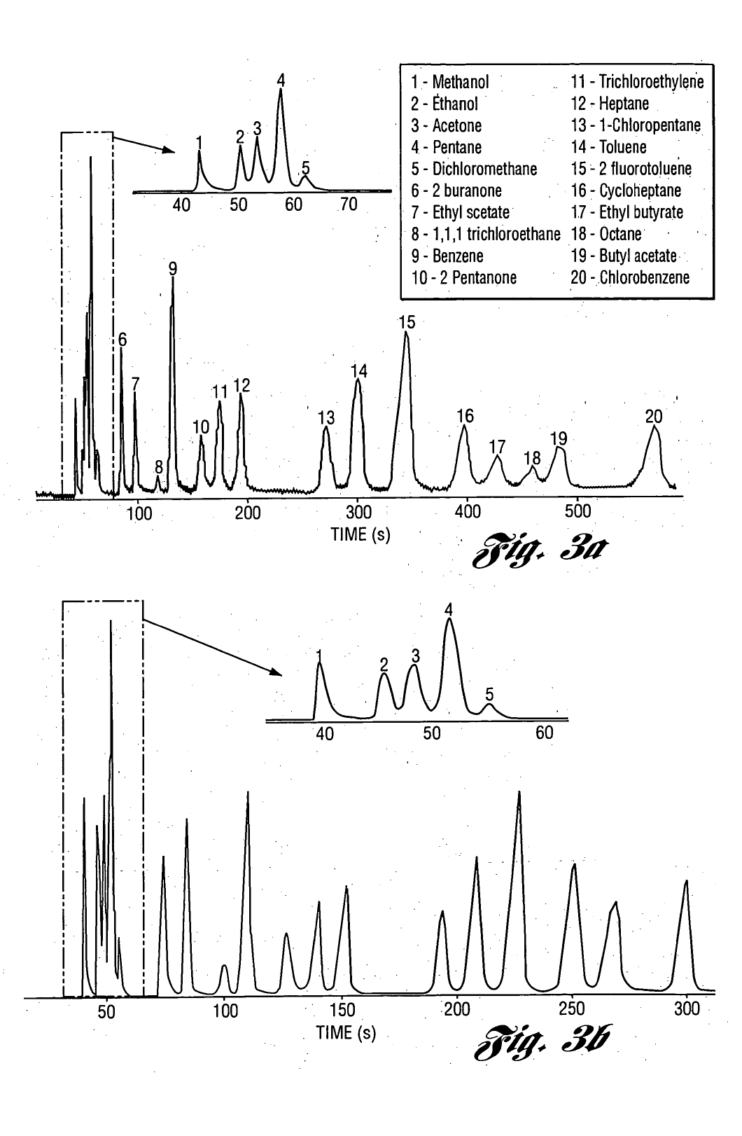

FIG. 3a displays the separation of 20 compounds obtained at room temperature. While the first five compounds are separated in about one minute, it takes about 10 minutes for chlorobenzene, which has a high boiling point (130° C.), to elute from the column. FIG. 3b shows a separation of the same mixture with the column run at 30° C. for 1 minute followed by a temperature ramp of 5° C./min for 5 minutes. Although less effective for low boiling compounds, this temperature program has reduced the analysis time for chlorobenzene by a factor of two. Using higher programming rates decreases the retention time more effectively but at the cost of resolution.

As described above, the assembly of one embodiment of the present invention includes silicon-glass μGC columns having integrated heaters and temperature sensors for temperature programming as well as pressure sensors for flow control. Twenty compounds are separated in less than 6 minutes. The 2000 ppm/° C. TCR of the temperature sensors and the 52 fF/kPa sensitivity of the pressure sensors are sufficient to achieve reproducible separations in a μGC system. The thermal time constant and transient power requirements of these columns are half of those of their predecessors [2].

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A high-performance separation microcolumn assembly comprising;
a substrate having a plurality of closed-spaced, gas flow microchannels etched therein;
a cover connected to the substrate to sealingly close the microchannels, the substrate and the cover forming a separation column; and
at least one heater and at least one sensor integrated with the separation column to enhance performance of the separation column.

2. The assembly as claimed in claim 1, wherein the substrate is a wafer-based substrate.

3. The assembly as claimed in claim 2, wherein the cover is a glass wafer bonded to the substrate.

4. The assembly as claimed in claim 1, wherein the at least one sensor includes at least one temperature sensor and wherein the at least one heater and the at least one temperature sensor allow the temperature of the separation column to be controlled.

5. The assembly as claimed in claim 1, wherein the at least one sensor includes a thermally-based microflow sensor.

6. The assembly as claimed in claim 4, wherein the at least one sensor also includes at least one pressure sensor to allow gas flow within the microchannels to be controlled.

7. The assembly as claimed in claim 6, wherein the at least one pressure sensor is disposed between the substrate and the cover in fluid communication with a port of the separation column.

8. In a microgas chromatograph system, a high-performance separation microcolumn assembly to separate a gas sample flowing therethrough into separate compounds, the assembly comprising:
a substrate having a plurality of closely-spaced, gas flow microchannels etched therein;
a cover connected to the substrate to sealingly close the microchannels, the substrate and the cover forming a separation column; and
at least one heater and at least one sensor integrated with the separation column to enhance separation of the gas sample flowing through the microchannels into separate compounds.

9. The assembly as claimed in claim 8, wherein the substrate is a wafer-based substrate.

10. The assembly as claimed in claim 9, wherein the cover is a glass wafer bonded to the substrate.

11. The assembly as claimed in claim 8, wherein the at least one sensor includes at least one temperature sensor and wherein the at least one heater and the at least one temperature sensor allow temperature of the separation column to be controlled.

12. The assembly as claimed in claim 8, wherein the at least one sensor includes a thermally-based microflow sensor.

13. The assembly as claimed in claim 11, wherein the at least one sensor also includes at least one pressure sensor to allow gas flow within the microchannels to be controlled.

14. The assembly as claimed in claim 13, wherein the at least one pressure sensor is disposed between the substrate and the cover in fluid communication with a port of the separation column.

15. A method of making a high-performance microcolumn assembly, the method comprising:
providing a substrate and a cover;
etching a plurality of closely-spaced, gas flow microchannels in the substrate;
connecting the cover to the substrate to sealingly close the microchannels and form a separation column; and
forming at least one heater and at least one sensor integrated with the separation column.

16. The method of claim 15, wherein the substrate is a wafer-based substrate and the cover is a glass wafer and wherein the step of connecting includes the step of bonding the glass wafer to the wafer-based substrate.

17. The method of claim 15, wherein the at least one sensor includes at least one pressure sensor and wherein the at least one pressure sensor is disposed between the substrate and the cover in fluid communication with a port of the separation column after the step of connecting.
